(19) United States
(12) Patent Application Publication
(10) Pub. No.: US 2014/0302361 A1
(43) Pub. Date: Oct. 9, 2014

(54) RECHARGEABLE BATTERY

(71) Applicant: SAMSUNG SDI CO., LTD., Yongin-si (KR)

(72) Inventors: Min-Yeol Han, Yongin-si (KR); Sang-Won Byun, Yongin-si (KR); Yong-Hee Yun, Yongin-si (KR); Su-Jin Yoon, Cheonan (KR)

(73) Assignee: SAMSUNG SDI CO., LTD., Yongin-si (KR)

(21) Appl. No.: 14/054,533

(22) Filed: Oct. 15, 2013

Related U.S. Application Data
(60) Provisional application No. 61/809,798, filed on Apr. 8, 2013.

(51) Int. Cl. H01M 2/36

(52) U.S. Cl. CPC H01M 2/364
USPC 429/82; 429/185

(57) ABSTRACT

A rechargeable battery including an electrode assembly including a first surface; a case containing the electrode assembly and an electrolyte solution; a cap plate covering an opening of the case and including a first surface spaced apart in a first direction from and facing the first surface of the electrode assembly; and an electrolyte solution absorption member inside the case and located between the first surface of the electrode assembly and the first surface of the cap plate in the first direction, the electrolyte solution absorption member configured to absorb a portion of the electrolyte solution.

### CROSS-REFERENCE TO RELATED APPLICATION

This application claims priority to and the benefit of U.S. Provisional Application No. 61/809,798, filed on Apr. 8, 2013 in the U.S. Patent and Trademark Office, the entire content of which is incorporated herein by reference.

### BACKGROUND

1. Field

Aspects of embodiments of the present invention relate to a rechargeable battery.

2. Description of the Related Art

A rechargeable battery is a battery that can be charged and discharged, unlike a primary battery that cannot be charged. A low-capacity rechargeable battery has been used for small portable electronic devices, such as a mobile phone, a laptop computer, and a camcorder, and a large-capacity battery has been used as a power supply for driving a motor, such as for an electric vehicle, a hybrid vehicle, and the like, or a large-capacity power storage device.

In recent years, a high-output rechargeable battery using a non-aqueous electrolytic solution having a high energy density has been developed. The high-output rechargeable battery is configured as a large-capacity battery module by connecting a plurality of rechargeable batteries in series to be able to be used to drive a motor of a device requiring large power, such as an electric vehicle, and the like. The rechargeable battery may be formed having a shape of a cylinder, a square, or the like.

In order to smoothly operate the rechargeable battery, an appropriate amount of electrolytic solution needs to be filled or injected into an electrode assembly of the rechargeable battery.

Therefore, an amount of the electrolytic solution injected into the rechargeable battery may be more than an amount of the electrolytic solution appropriately filled into an electrode assembly, or an electrolytic solution equal to an amount of the electrolytic solution appropriately filled into the electrode assembly may be injected into a case.

However, when the electrolytic solution is larger than the amount of the electrolytic solution appropriately filled into the electrode assembly, a residual electrolytic solution E that is not contained within the electrode assembly is generated in the case, and may thereby cause a short circuit in the case.

Further, in order to inject the electrolytic solution equal to the amount of the electrolytic solution appropriately filled into the electrode assembly into the rechargeable battery, there is a need to stop injecting the electrolytic solution and then measure the amount of the electrolytic solution supplied to the rechargeable battery, such that an injection process time of the electrolytic solution may be increased.

### SUMMARY

According to an aspect of embodiments of the present invention, an absorption member is capable of absorbing a residual electrolytic solution in a rechargeable battery and shortening an injection process time of the electrolytic solution. According to another aspect of embodiments of the present invention, a rechargeable battery includes a structure capable of minimizing or reducing a residual electrolytic solution in a case.

According to one or more embodiments of the present invention, a rechargeable battery includes: an electrode assembly including a first surface; a case containing the electrode assembly and an electrolyte solution; a cap plate covering an opening of the case and including a first surface spaced apart in a first direction from and facing the first surface of the electrode assembly; and an electrolyte solution absorption member inside the case and located between the first surface of the electrode assembly and the first surface of the cap plate in the first direction, the electrolyte solution absorption member configured to absorb a portion of the electrolyte solution.

The electrolyte solution absorption member may be made of an insulating material.

The electrolyte solution absorption member may include an electrolyte solution absorbing material.

The electrolyte solution absorption member may be attached to the cap plate via an adhesive.

The electrolyte solution absorption member may include a thin plate or sheet.

The electrolyte solution absorption member may include a porous film or a fiber fabric.

The electrolyte solution absorption member may have a plurality of nano-sized openings.

The electrolyte solution absorption member may include a porous film of at least one of polyolefin or polyvinylidene fluoride.

The rechargeable battery may further include a terminal electrically coupled to the electrode assembly and protruding through the cap plate, and the electrolyte solution absorption member may have a first opening through which the terminal passes.

The cap plate may have an electrolyte injection opening, and the electrolyte solution absorption member may have a third opening at a location corresponding to the electrolyte injection opening of the cap plate.

The cap plate may have a vent opening, and the electrolyte solution absorption member may have a fourth opening at a location corresponding to the vent opening of the cap plate.

The electrolyte solution absorption member may be coupled to the first surface of the cap plate. The rechargeable battery may further include an auxiliary electrolyte solution absorption member inside the case and coupled to a side wall of the case.

The auxiliary electrolyte solution absorption member may be on a portion of the side wall of the case at a location between the first surface of the electrode assembly and the first surface of the cap plate in the first direction.

The auxiliary electrolyte solution absorption member may have a ring shape corresponding to a shape of an inner surface of the side wall of the case.

The electrolyte solution absorption member may include a flat portion and a protruding portion surrounding a periphery of the flat portion.

The flat portion may be coupled to the first surface of the cap plate, and the protruding portion may protrude in a direction toward the first surface of the electrode assembly. The protruding portion may protrude from an edge of the flat portion.

The protruding portion may contact an inner surface of a side wall of the case.

A surface of the protruding portion facing the first surface of the electrode assembly may be angled with respect to the flat portion.

According to one or more embodiments of the present invention, a rechargeable battery includes an electrode assembly, a case for mounting the electrode assembly and an electrolyte solution therein, and a cap plate for closing an opening of the case, and an electrolyte solution absorption member is provided inside the case coupled to the cap plate.

According to an aspect of embodiments of the present invention, the residues of the electrolytic solution in the case can be minimized or reduced by the absorption member disposed in the case to absorb the residual electrolytic solution to prevent or substantially prevent an internal short circuit from occurring due to the residual electrolytic solution and shortening the operation time for controlling an amount of the residual electrolytic solution in the case, thereby improving the productivity of the rechargeable battery.

In an exemplary embodiment, the absorption member is provided on the surface of the cap plate facing the electrode assembly. In this way, the electrolyte solution can be absorbed at a location spaced apart from the electrode assembly, thereby reducing the risk of a short circuit.

In one exemplary embodiment, the electrolyte solution absorption member is attached to the cap plate via an adhesive, thereby simplifying the assembly of the battery and the fixing of the electrolyte solution absorption member to the cap plate.

In one embodiment, the electrolyte solution absorption member includes or consists of an electrolyte solution absorbing material. That is, the material of the electrolyte solution absorption member provides the electrolyte solution absorbing effect more than the shape of the electrolyte solution absorption member. In an exemplary embodiment, the electrolyte solution absorption member includes a porous film or a fiber fabric. The porous film and the fiber fabric may be formed of at least one of porous materials, and may have a plurality of nano-sized openings to absorb and contain an electrolyte solution therein. The porous film may be formed of at least one of polyolefin and polyvinylidene fluoride.

The electrolyte solution absorption member, in an exemplary embodiment, is a thin absorption sheet.

The battery may further include a first terminal rivet coupled to a first electrode of the electrode assembly and protruding from the inside of the case through the cap plate, and the electrolyte solution absorption member may include a first groove for passing the first terminal rivet therethrough.

In one embodiment, the rechargeable battery may further include a second terminal rivet coupled to a second electrode of the electrode assembly and protruding from the inside of the case through the cap plate, and the electrolyte solution absorption member may include a second groove for passing the second terminal rivet therethrough.

The cap plate may include an electrolyte injection port, and the electrolyte solution absorption member may include an electrolyte injection port groove formed at a location corresponding to the location of the electrolyte injection port.

The cap plate may include a vent hole, and the electrolyte solution absorption member may include a vent hole groove formed at a location corresponding to the location of the vent hole.

The rechargeable battery may further include an auxiliary electrolyte solution absorption member coupled to at least one side surface of the case at a vertical location above the electrode assembly and below the cap plate.

The auxiliary electrolyte solution absorption member, in an exemplary embodiment, includes an electrolyte solution absorbing material, and may be a similar electrolyte solution absorbing material as the electrolyte solution absorption member.

The auxiliary electrolyte solution absorption member may have a shape of a ring or a shape corresponding to a lateral cross-section of the case and may be fixed or laminated to the interior of the case.

The electrolyte solution absorption member may comprise a flat part, and a protruding part protruding in a direction away from the cap plate toward the electrode assembly.

The protruding part may protrude along an edge of the flat part, and the flat part may be coupled to the cap plate. The protruding part may form a closed curve on the edge of the flat part. An inner circumference of the protruding part may be angled with respect to the flat part.

### BRIEF DESCRIPTION OF THE DRAWINGS

The accompanying drawings, together with the specification, illustrate some exemplary embodiments of the present invention, and, together with the description, serve to explain principles and aspects of the present invention.

FIG. 1 is a perspective view of a rechargeable battery according to an exemplary embodiment of the present invention.

FIG. 2 is a cross-sectional view of the rechargeable battery of FIG. 1, taken along the line II-II.

FIG. 3 is a partial exploded perspective view of the rechargeable battery of FIG. 1.

FIG. 4 is a bottom perspective view illustrating a state in which an absorption member and a cap plate of the rechargeable battery of FIG. 1 are coupled with each other.

FIG. 5 is a cross-sectional view illustrating a state in which a residual electrolytic solution in the rechargeable battery of FIG. 1 is absorbed in the absorption member of FIG. 4.

FIG. 6 is a partial exploded perspective view of a rechargeable battery according to another exemplary embodiment of the present invention.

FIG. 7 is a cross-sectional view of the rechargeable battery of FIG. 6, taken along the line VII-VII, illustrating a state in which a residual electrolytic solution is absorbed in an absorption member.

FIG. 8 is a partial exploded perspective view of a rechargeable battery according to another exemplary embodiment of the present invention.

FIG. 9 is a cross-sectional view of the rechargeable battery of FIG. 8, taken along the line IX-IX, illustrating a state in which a residual electrolytic solution is absorbed in an absorption member.

FIG. 10 is a cross-sectional view of the rechargeable battery of FIG. 8, taken along the line X-X, illustrating a state in which a residual electrolytic solution is absorbed in an absorption member.

### DETAILED DESCRIPTION

In the following detailed description, certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

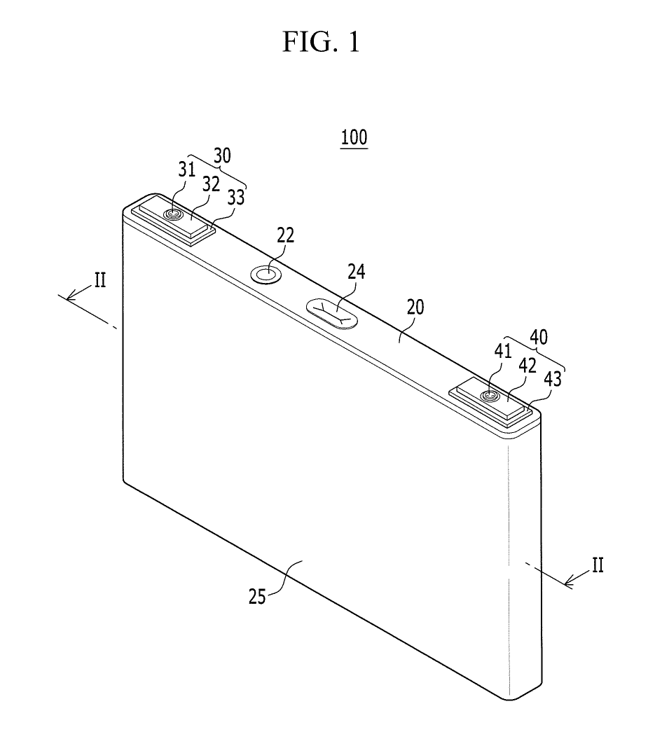

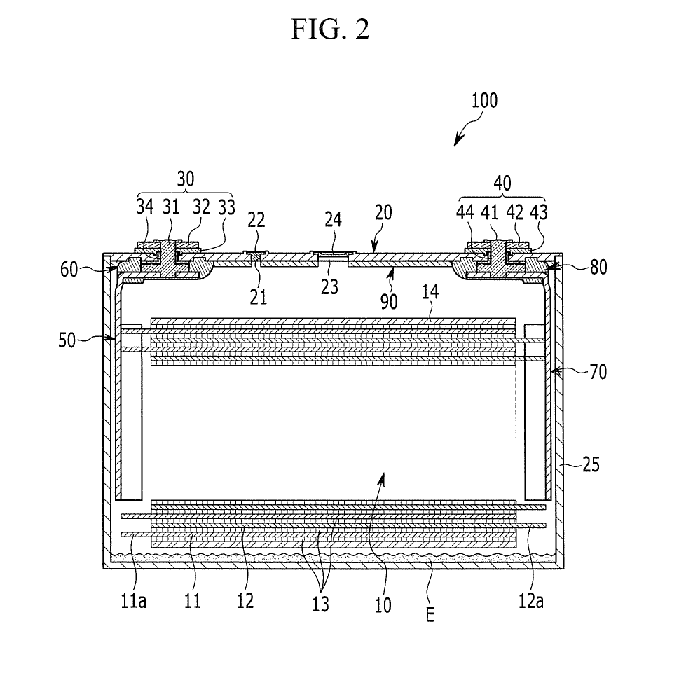

FIG. 1 is a perspective view illustrating a rechargeable battery according to an exemplary embodiment of the present invention; and FIG. 2 is a cross-sectional view of the rechargeable battery of FIG. 1, taken along the line II-II.

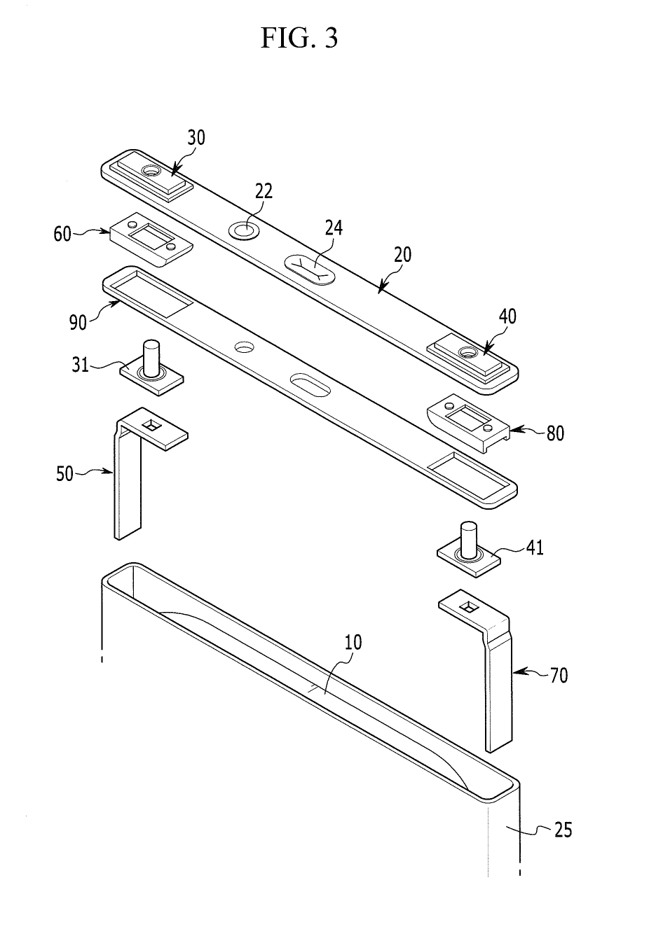

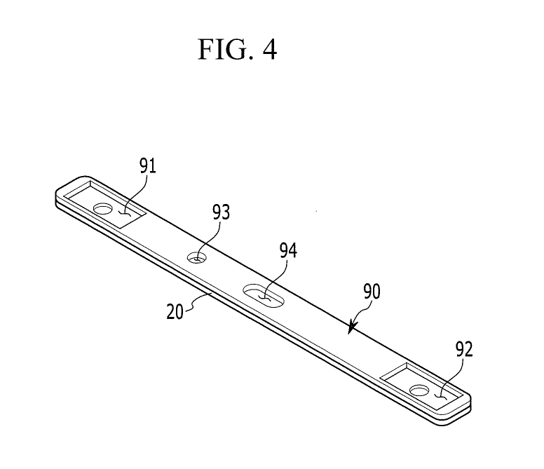

Further, FIG. 3 is a partial exploded perspective view of the rechargeable battery of FIG. 1; and FIG. 4 is a bottom perspective view illustrating a state in which an absorption member and a cap plate of the rechargeable battery of FIG. 1 are coupled with each other.

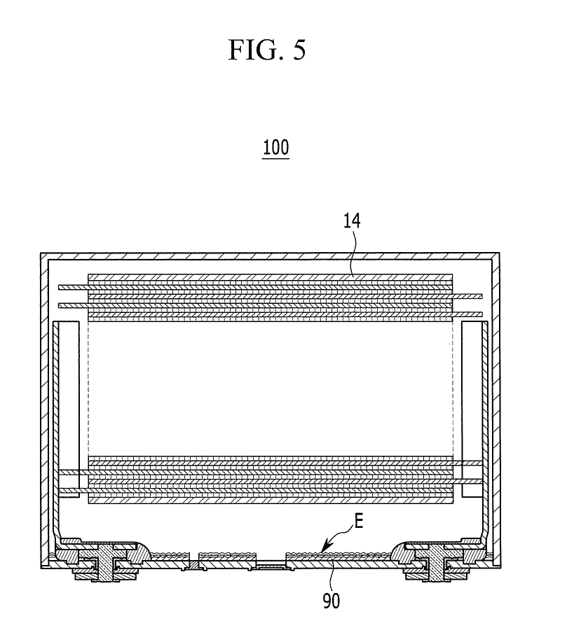

FIG. 5 is a cross-sectional view illustrating a state in which a residual electrolytic solution in the rechargeable battery of FIG. 1 is absorbed in the absorption member of FIG. 4.

Referring to FIGS. 1 and 2, a rechargeable battery 100 according to an exemplary embodiment of the present invention includes an electrode assembly 10, a case 25 in which the electrode assembly 10 is embedded or contained, a first terminal part 30 and a second terminal part 40 that are electrically connected with the electrode assembly 10, a cap plate 20, first and second lower insulating members 60 and 80, and an electrolyte solution absorption member 90, or absorption member 90, that is coupled with the cap plate 20.

The rechargeable battery 100 according to an exemplary embodiment of the present invention is a lithium ion rechargeable battery and will be described as a square or prismatic rechargeable battery, by way of example. However, embodiments of the present invention are not limited thereto, but may be applied to a battery, such as a lithium polymer battery, and the like.

The electrode assembly 10 according to an embodiment of the present invention has a jelly roll form in which a first electrode 11, a second electrode 12, and a separator 13 are wound.

Further, a surface of the electrode assembly 10 according to an embodiment of the present invention may be coupled with an insulating tape 14 to insulate the electrode assembly 10 from the case 25.

According to an embodiment of the present invention, the first electrode 11 is a negative electrode, and the second electrode 12 is a positive electrode.

However, the present invention is not limited thereto, and, in another embodiment, the first electrode 11 may be used as a positive electrode, and the second electrode 12 may be as a negative electrode.

The first electrode 11 is wound to be disposed at an outermost side of the electrode assembly 10 according to an embodiment of the present invention.

In addition, the first electrode 11 and the second electrode 12 are partitioned into a coated part in which a current collector is coated with an active material, and a first electrode uncoated part 11a and a second electrode uncoated part 12a that are disposed at opposite sides of the coating part in the jelly roll state and on which the current collector is not coated with the active material.

The first electrode uncoated part 11a of the electrode assembly 10 is electrically connected with the first terminal part 30 via a first electrode current collecting member 50, and the second electrode uncoated part 12a is electrically connected with the second terminal part 40 via a second electrode current collecting member 70.

Further, the first and second terminal parts 30 and 40 include first and second rivets 31 and 41, first and second terminal plates 32 and 42, a first terminal insulating member 33 that is disposed between the first terminal plate 32 and the cap plate 20, a second connection plate 43 that is disposed between the second terminal plate 42 and the cap plate 20, and first and second gaskets 34 and 44.

The second terminal plate 42 according to an embodiment of the present invention is made of a conductive material.

In addition, the cap plate 20 according to an embodiment of the present invention has a thin panel or plate shape and is made of a conductive material and coupled with an opening of the case 25 to seal the opening.

The cap plate 20 is provided with an electrolyte injection port 21 through which an electrolytic solution is injected into the sealed case 25, and the electrolyte injection port 21 is used to inject the electrolytic solution and then is sealed by a sealing stopper 22.

The cap plate 20, in one embodiment, is provided with a vent hole 23 that is provided with a vent plate 24 that is fractured when an internal pressure of the sealed case 25 exceeds a certain pressure (e.g., a predetermined pressure).

The cap plate 20 according to an embodiment of the present invention may be electrically connected with the second electrode 12 via the second terminal plate 42, the second connection plate 43, and the second electrode current collecting member 70.

The case 25, in one embodiment, has a substantially rectangular parallelepiped shape and is made of a conductive material, and one surface of the case 25 is provided with an opening through which the electrode assembly 10 is inserted.

In addition, the case 25 according to an embodiment of the present invention may be electrically connected with the second electrode 12 via the cap plate 20.

However, embodiments of the present invention are not limited thereto, but the case may be formed in various shapes, such as a cylindrical shape, a pouch shape, and the like.

Further, the first and second lower insulating members 60 and 80 are disposed to be adjacent to the cap plate 20 within the case 25.

Referring to FIGS. 3 and 4, the absorption member 90 according to an exemplary embodiment of the present invention is coupled with a surface of the cap plate 20 that faces the inside of the case 25.

The absorption member 90 according to an exemplary embodiment of the present invention has a thin plate shape and is made of an absorbing material and an insulating material.

In addition, the absorbing member 90 according to an embodiment of the present invention includes a first groove 91, a second groove 92, a third groove 93, and a fourth groove 94.

The first groove 91 of the absorbing member 90 according to an embodiment of the present invention is coupled with the first lower insulating member 60, and the second groove 92 is coupled with the second lower insulating member 80.

Further, the third groove or electrolyte injection port groove 93 of the absorbing member 90 according to an embodiment of the present invention is formed at a place facing the electrolyte injection port 21 such that the electrolyte injection port 21 is exposed within the case 25.

In addition, the fourth groove or vent hole groove 94 of the absorbing member 90 according to an embodiment of the present invention is formed at a place facing the vent hole 23 such that the vent hole 23 is exposed within the case 25.

A residual electrolytic solution E is absorbed in the absorbing member 90 to prevent or substantially prevent a short circuit, as described below in further detail.

FIG. 5 is a cross-sectional view illustrating the state in which the residual electrolytic solution E in the rechargeable battery 100 is absorbed in the absorption member 90.

Referring to FIGS. 2 and 5, the absorption member 90 according to an exemplary embodiment of the present invention may be coupled with a surface of the cap plate 20 facing the electrode assembly 10 to be disposed between the electrode assembly 10 and the cap plate 20.

In order to smoothly operate the electrode assembly 10, an appropriate amount of the electrolytic solution needs to be filled or inserted into the electrode assembly 10.

Therefore, the amount of the electrolytic solution injected into the case 25 may be more than the amount of the electrolytic solution appropriately filled into the electrode assembly 10.

When the amount of the electrolytic solution injected into the case 25 is more than the amount of the electrolytic solution appropriately filled into the electrode assembly 10, as illustrated in FIG. 2, the residual electrolytic solution E that is not contained within the electrode assembly 10 is generated within the case 25.

The residual electrolytic solution E may be a factor that causes a short circuit within the case 25.

That is, the first electrode 11 is disposed at an outermost side of the electrode assembly 10 according to an embodiment of the present invention, and the case 25 is electrically connected with the second electrode 12 via the cap plate 20.

Further, the residual electrolytic solution E is disposed between the first electrode 11 and a bottom surface of the case 25.

In this case, the first electrode 11 and the case 25 may maintain a state in which the first electrode 11 and the case 25 are not electrically connected with each other by the insulating tape 14, that is, an insulating state.

However, the insulating tape 14 that is coupled with the surface of the electrode assembly 10 may be damaged due to external impact, heat generated from the inside of the case 25, and the like.

Therefore, when the insulating tape 14 is damaged due to external impact, heat, and the like, such that the first electrode 11 is electrically connected with the case 25 via the residual electrolytic solution E that is stagnated in the bottom of the case 25 disposed at a side facing the cap plate 20, a current path is formed between the first electrode 11 and the second electrode 12 to cause a short circuit within the case 25.

The absorption member 90 according to an exemplary embodiment of the present invention may prevent or substantially prevent a short circuit from occurring within the case 25 due to the residual electrolytic solution E.

As illustrated in FIG. 5, when the case 25 is rotated clockwise or counterclockwise or inverted such that the cap plate 20 faces a gravity direction, or, in other words, a normal to the cap plate 20 pointing away from the case 25 is parallel to the direction of gravity, the residual electrolytic solution E remaining in the case 25 is absorbed in the absorption member 90 disposed in the case 25.

The absorption member 90 according to an exemplary embodiment of the present invention is made of a material that may appropriately absorb the residual electrolytic solution E.

Consequently, according to an exemplary embodiment of the present invention, since the residual electrolytic solution E is absorbed in the absorption member 90, it is possible to prevent or substantially prevent a short circuit from occurring within the case 25 by the residual electrolytic solution E even when the insulating tape 14 is damaged.

Further, in order to prevent or substantially prevent the residual electrolytic solution E from occurring within the case 25, an amount equal to the amount of the electrolytic solution appropriately filled into the electrode assembly 10 may be injected into the case 25.

However, in a comparable process, in order to inject the electrolytic solution into the case 25 in the amount of electrolytic solution appropriately filled into the electrode assembly 10, there would be a need to stop injecting the electrolytic solution and then measure the amount of the electrolytic solution supplied into the case 25.

Therefore, in a comparable process, in order to prevent or substantially prevent the residual electrolytic solution E from occurring within the case 25, the injection of the electrolytic solution would needs to stop or the injection speed of the electrolytic solution would need to be delayed, such that an injection process time of the electrolytic solution would be increased.

However, according to exemplary embodiments of the present invention, there is no need to measure the injected amount of the electrolytic solution enough to prevent or substantially prevent the residual electrolytic solution E from occurring within the case 25.

That is, according to exemplary embodiments of the present invention, even though the residual electrolytic solution E is generated due to the supply of the electrolytic solution into the case 25, the residual electrolytic solution E may be removed by the absorption member 90, such that there is no need to measure the injected amount of the electrolytic solution as in a comparable process.

The absorption member 90, in an exemplary embodiment, is attached to the cap plate 20 via an adhesive. Furthermore, the absorption member 90 may comprise or consist of an electrolyte solution absorbing material. The electrolyte solution absorption member 90 may comprise a porous film or a fiber fabric. The porous film and the fiber fabric may be formed of at least one of porous materials and may have a plurality of nano-sized openings to absorb and contain an electrolyte solution therein. In one embodiment, the porous film may be formed of at least one of polyolefin and polyvinylidene fluoride.

Therefore, according to exemplary embodiments of the present invention, there is no need to stop injecting the electrolytic solution or delay the injection speed of the electrolytic solution in order to measure the injected amount of the electrolytic solution such that the injection process time of the electrolytic solution is shortened, thereby improving the productivity of the rechargeable battery.

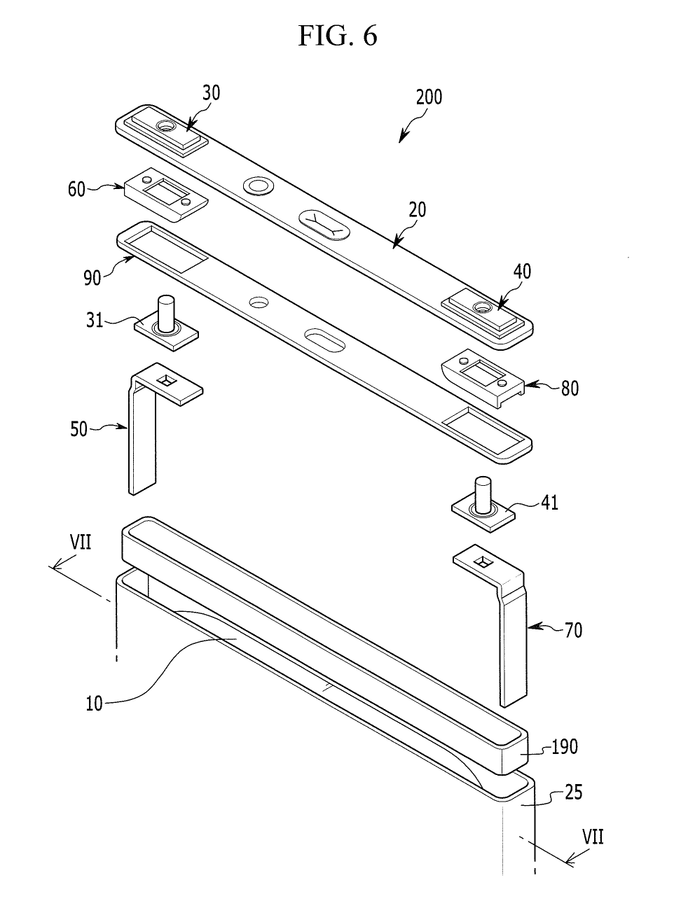

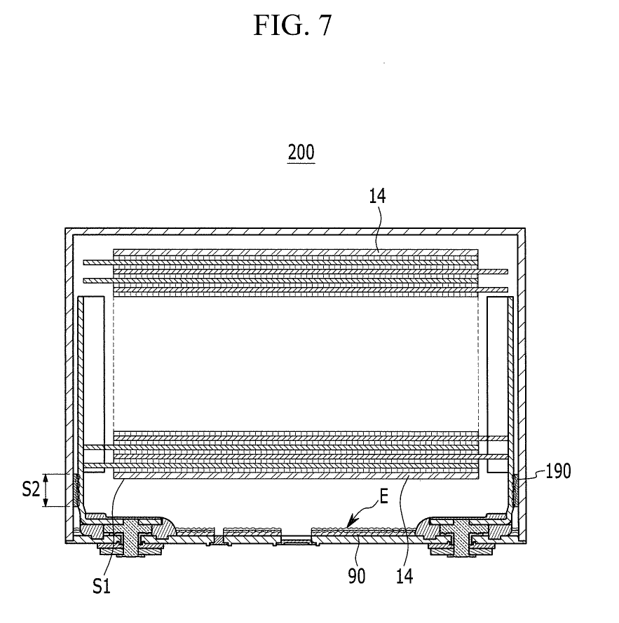

FIG. 6 is an exploded perspective view of a rechargeable battery according to another exemplary embodiment of the present invention; and FIG. 7 is a cross-sectional view of the rechargeable battery of FIG. 6, taken along the line VII-VII, illustrating a state in which a residual electrolytic solution is absorbed in an absorption member.

Referring to FIGS. 6 and 7, a rechargeable battery 200 according to another exemplary embodiment of the present invention has a same configuration as the rechargeable battery 100 described above, except for an auxiliary absorption member 190.

Therefore, further description of the same components as those of the rechargeable battery 100 described above will not be repeated.

The auxiliary absorption member 190 according to an exemplary embodiment of the present invention is coupled with a side of the case 25 within the case 25.

In one embodiment, as shown in FIG. 7, the auxiliary absorption member 190 is coupled with a first portion S2 of an inner side of the case 25 that is disposed above a first or upper surface S1 of the electrode assembly 10 facing the cap plate 20.

The electrolytic solution injected through the electrolyte injection port 21 may be filled up to the first surface S1 of the electrode assembly 10 within the case 25.

Therefore, the electrolytic solution is not absorbed in the auxiliary absorption member 190 coupled with the first portion S2 of the case 25 that is disposed above the first surface S1 of the electrode assembly 10 during the injection of the electrolytic solution.

As illustrated in FIG. 7, when the case 25 is rotates clockwise or counterclockwise or inverted such that the cap plate 20 faces a gravity direction, or, in other words, a normal to the cap plate 20 pointing away from the case 25 is parallel to the direction of gravity, the residual electrolytic solution E remaining in the case 25 may be absorbed in the absorption member 90 and the auxiliary absorption member 190 disposed in the case 25.

When the case 25 is rotated clockwise or counterclockwise or inverted, the residual electrolytic solution E flows down along a side wall within the case 25.

Therefore, the residual electrolytic solution E is primarily absorbed in the auxiliary absorption member 190 coupled with the first portion S2 of the side wall within the case 25 and the residual electrolytic solution E that is not absorbed in the auxiliary absorption member 190 is absorbed in the absorption member 90.

Consequently, the residual electrolytic solution E within the case 25 may be quickly removed by the auxiliary absorption member 190 according to an exemplary embodiment of the present invention.

Further, according to an exemplary embodiment of the present invention, a large amount of residual electrolytic solution E may be removed by the absorption member 90 and the auxiliary absorption member 190.

According to another embodiment of the present invention, the absorption member 90 may not be included in the rechargeable battery 200. That is, the rechargeable battery 200, in another embodiment, may include the auxiliary absorption member 190 coupled on an inner side wall of the case 25, while not including the absorption member 90 coupled with a surface of the cap plate 20.

Therefore, according to an exemplary embodiment of the present invention, it is possible to prevent or substantially prevent a short circuit from occurring within the case 25 due to the residual electrolytic solution E, and the injection process time of the electrolytic solution may be shortened, thereby improving the productivity of the rechargeable battery.

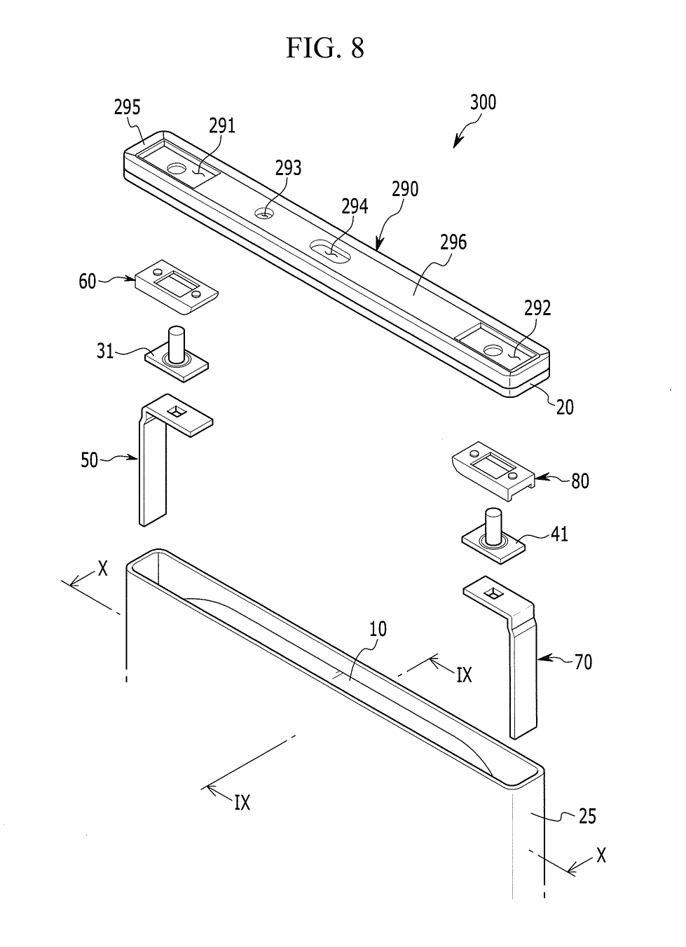

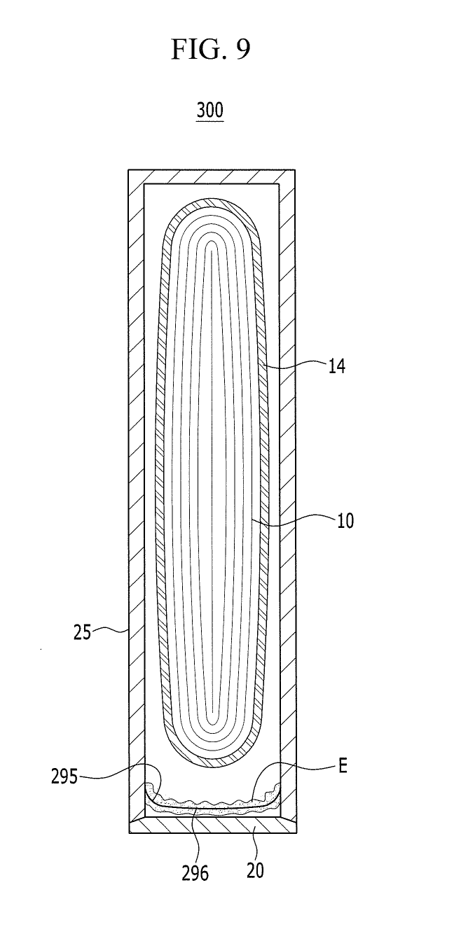

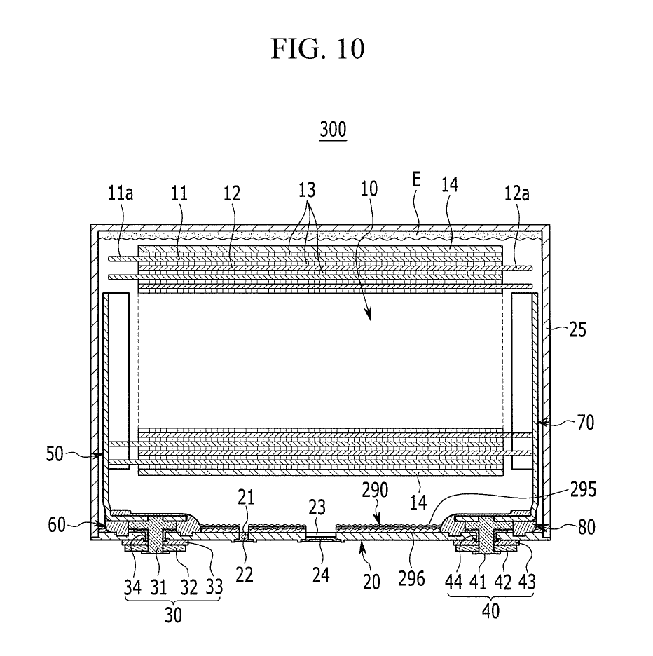

FIG. 8 is an exploded perspective view of a rechargeable battery according to another exemplary embodiment of the present invention; FIG. 9 is a cross-sectional view of the rechargeable battery of FIG. 8, taken along the line IX-IX, illustrating a state in which a residual electrolytic solution is absorbed in an absorption member; and FIG. 10 is a cross-sectional view of the rechargeable battery of FIG. 8, taken along the line X-X, illustrating a state in which a residual electrolytic solution is absorbed in an absorption member.

Referring to FIGS. 8 to 10, a rechargeable battery 300 according to another exemplary embodiment of the present invention has a same configuration as the rechargeable battery 100 described above, except for an absorption member 290.

Therefore, further description of the same components as those of the rechargeable battery 100 described above will not be repeated.

Referring to FIG. 8, the absorption member 290 according to an exemplary embodiment of the present invention includes a first groove 291, a second groove 292, a third groove 293, a fourth groove 294, a protruding part 295, and a flat part 296. In order to illustrate the shape of the absorption member 290, the cap plate 20 together with the absorption member 290 is shown upside down in FIG. 8. Thus, for assembly of the rechargeable battery 300, the upper side of the absorption member 290 as shown in FIG. 8 becomes the lower side of the absorption member 290 facing the electrode assembly 10 after assembly.

The first to fourth grooves 291, 292, 293, and 294 according to an embodiment of the present invention may have a same configuration as the first to fourth grooves 91, 92, 93, and 94 of the absorption member 90 described above, and, therefore, further detailed description of the first to fourth grooves 291, 292, 293, and 294 and their coupling relationship with other components will be omitted.

According to an exemplary embodiment of the present invention, the flat part 296 is provided with the first groove 291, the second groove 292, the third groove or electrolyte injection port groove 293, and the fourth groove or vent hole groove 294, and one surface of the flat part 296 is coupled with a surface of the cap plate 20 facing the inside of the case 25.

The protruding part 295 according to an exemplary embodiment of the present invention protrudes along an edge of the flat part 296.

In more detail, the protruding part 295 according to an exemplary embodiment of the present invention protrudes, forming a closed curve along an edge of the flat part 296.

In one embodiment, the protruding part 295 may protrude by forming an angle (e.g., a predetermined angle) with respect to the flat part 296.

According to an exemplary embodiment of the present invention, when the cap plate 20 is coupled with the opening of the case 25, the protruding part 295 coupled with the cap plate 20 faces the inside of the case 25.

In this case, the absorption member 290 is disposed within the case 25 in the state in which the protruding part 295 contacts a part of a side wall within the case 25.

As illustrated in FIGS. 9 and 10, when the case 25 is rotated clockwise or counterclockwise or inverted such that the cap plate 20 faces a gravity direction, or, in other words, a normal of the cap plate 20 pointing away from the case 25 is parallel to the direction of gravity, the residual electrolytic solution E remaining in the case 25 may be absorbed in the absorption member 290 disposed in the case 25.

When the case 25 is rotated clockwise or counterclockwise or inverted, the residual electrolytic solution E flows down along the side wall within the case 25.

Therefore, the residual electrolytic solution E is primarily absorbed in the protruding part 295 of the absorption member 290 contacting the side wall within the case 25 and the residual electrolytic solution E that is not absorbed in the protruding part 295 is absorbed in the flat part 296 of the absorption member 290.

Consequently, according to an exemplary embodiment of the present invention, the residual electrolytic solution E flowing down along the side wall within the case 25 may be quickly removed by the protruding part 295 of the absorption member 290.

Further, according to an exemplary embodiment of the present invention, a large amount of residual electrolytic solution E may be removed by the protruding part 295 and the flat part 296 of the absorption member 290.

According to another embodiment of the present invention, the rechargeable battery 300 may further include the auxiliary absorption member 190 described above coupled on an inner side wall of the case 25, while also including the absorption member 290 coupled with a surface of the cap plate 20.

Therefore, according to embodiments of the present invention, it is possible to prevent or substantially prevent a short circuit from occurring within the case 25 due to the residual electrolytic solution E, and the injection process time of the electrolytic solution may be shortened, thereby improving the productivity of the rechargeable battery.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A rechargeable battery comprising:
an electrode assembly comprising a first surface;
a case containing the electrode assembly and an electrolyte solution;
a cap plate covering an opening of the case and comprising a first surface spaced apart in a first direction from and facing the first surface of the electrode assembly; and
an electrolyte solution absorption member inside the case and located between the first surface of the electrode assembly and the first surface of the cap plate in the first direction, the electrolyte solution absorption member configured to absorb a portion of the electrolyte solution.

2. The rechargeable battery of claim 1, wherein the electrolyte solution absorption member is made of an insulating material.

3. The rechargeable battery of claim 1, wherein the electrolyte solution absorption member comprises an electrolyte solution absorbing material.

4. The rechargeable battery of claim 1, wherein the electrolyte solution absorption member is attached to the cap plate via an adhesive.

5. The rechargeable battery of claim 1, wherein the electrolyte solution absorption member comprises a thin plate or sheet.

6. The rechargeable battery of claim 1, wherein the electrolyte solution absorption member comprises a porous film or a fiber fabric.

7. The rechargeable battery of claim 1, wherein the electrolyte solution absorption member has a plurality of nano-sized openings.

8. The rechargeable battery of claim 1, wherein the electrolyte solution absorption member comprises a porous film of at least one of polyolefin or polyvinylidene fluoride.

9. The rechargeable battery of claim 1, further comprising a terminal electrically coupled to the electrode assembly and protruding through the cap plate, wherein the electrolyte solution absorption member has a first opening through which the terminal passes.

10. The rechargeable battery of claim 1, wherein the cap plate has an electrolyte injection opening, and the electrolyte solution absorption member has a third opening at a location corresponding to the electrolyte injection opening of the cap plate.

11. The rechargeable battery of claim 1, wherein the cap plate has a vent opening, and the electrolyte solution absorption member has a fourth opening at a location corresponding to the vent opening of the cap plate.

12. The rechargeable battery of claim 1, wherein the electrolyte solution absorption member is coupled to the first surface of the cap plate.

13. The rechargeable battery of claim 12, further comprising an auxiliary electrolyte solution absorption member inside the case and coupled to a side wall of the case.

14. The rechargeable battery of claim 13, wherein the auxiliary electrolyte solution absorption member is on a portion of the side wall of the case at a location between the first surface of the electrode assembly and the first surface of the cap plate in the first direction.

15. The rechargeable battery of claim 13, wherein the auxiliary electrolyte solution absorption member has a ring shape corresponding to a shape of an inner surface of the side wall of the case.

16. The rechargeable battery of claim 1, wherein the electrolyte solution absorption member comprises a flat portion and a protruding portion surrounding a periphery of the flat portion.

17. The rechargeable battery of claim 16, wherein the flat portion is coupled to the first surface of the cap plate, and the protruding portion protrudes in a direction toward the first surface of the electrode assembly.

18. The rechargeable battery of claim 17, wherein the protruding portion protrudes from an edge of the flat portion.

19. The rechargeable battery of claim 16, wherein the protruding portion contacts an inner surface of a side wall of the case.

20. The rechargeable battery of claim 16, wherein a surface of the protruding portion facing the first surface of the electrode assembly is angled with respect to the flat portion.
